(19) United States
(12) Patent Application Publication
(10) Pub. No.: US 2007/0015130 A1
(43) Pub. Date: Jan. 18, 2007

(54) Specialized merchandising system

(76) Inventor: Andrew P. Meurer, Cincinnati, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/527,274

(22) Filed: Sep. 26, 2006

Related U.S. Application Data
(63) Continuation of application No. 09/812,376, filed on Mar. 20, 2001, now abandoned.

(51) Int. Cl. G09B 25/00

(52) U.S. Cl. 434/365

(57) ABSTRACT

A specialized merchandizing system for a particular type of consumer is provided comprising a partitioned section within a retail establishment constructed with interior designs reflecting characteristics of the particular type of consumer and providing a variety of products fulfilling the particular type of consumer's needs. The specialized merchandising includes a multipurpose customer interaction center equipped with computer terminals, an area where customers can socialize, an activity area for children, and public speaking accommodations for guest speakers presenting topics of interest to the particular type of consumer.

### CROSS REFERENCE TO RELATED APPLICATION

This application is a continuation of Application Ser. No. 09/812,376, filed Mar. 20, 2001.

### FIELD OF THE INVENTION

The present invention is directed to a merchandising system within a retail establishment and relates in particular to a merchandising system within a store designed for a particular type of consumer.

### BACKGROUND OF THE INVENTION

In order to better accommodate consumers, retail establishments have continuously strived to attract customers by providing one stop shopping where customers can purchase all of their consumer needs in a single retail establishment. As a result, retail establishments have grown from the traditional mom and pop corner stores selling specific types of products such as groceries, pharmaceuticals, automotive parts, or clothing to large superstores selling a variety products. The variety of products sold in these large superstores includes groceries, personal hygiene products, pharmaceuticals, automotive parts, clothing, toys, and electronics all in one establishment.

Although these large superstores have generally succeeded in making one stop shopping available to consumers, the shopping experience associated with these establishments have become very unpleasant for the consumers and have made it virtually impossible for parents to shop with children. The superstores have grown so large that it is often difficult for consumers to find the product they are looking for. Making matters worse, the emergence of the large superstore has had a great effect on customer service since the ratio of store clerks to consumers has largely diminished. As a result, consumers are forced to search endless aisles for products meeting their particular needs. What's more, products manufactured for a particular type of consumer are seldom displayed together in the same location and often times not even the same aisle requiring consumers to partake on an expedition throughout the entire store. Further, even though the stores have grown to mega proportions, products offered for sale are generally limited to general product brands. Consequently, consumers searching for specialty items are forced to go elsewhere to meet their needs.

Accordingly, it would be desirable to provide a merchandising system for retail establishments that offers a variety of products and services meeting all of the needs of a particular type of consumer in one location. In addition, it would be desirable to provide merchandising system creating an atmosphere favorable to a specific type of consumer. Finally it would be desirable to provide a merchandising system offering a pleasant shopping experience for the consumer.

### SUMMARY OF THE INVENTION

In accordance with one aspect of the present invention, a specialized merchandising system for a particular type of consumer is provided comprising a partitioned section within a retail establishment constructed with interior designs reflecting characteristics of the particular type of consumer and providing a variety of products fulfilling the particular type of consumer's needs. The specialized merchandising system may include, but is not limited to, a multipurpose customer interaction center equipped with a plurality of customer accessible computer terminals, an area where customers can socialize, an activity area for children, and public speaking accommodations for guest speakers presenting topics of interest to the particular consumer. The computer terminals provide Internet access for online shopping, access to educational materials and scheduling features that can be utilized to facilitate planning activities, celebrations and other events. The specialized merchandising system may include a nutrition center displaying food products, an equipment center displaying furnishings, a personal hygiene center displaying personal care products (disposables/lotions/soaps shampoos); and a clothing center displaying fashions, all of which are designed for the particular type of consumer.

### BRIEF DESCRIPTION OF THE DRAWINGS

While the specification concludes with claims particularly pointing out and distinctly claiming the subject matter which is regarded as forming the present invention, it is believed that the invention will be better understood from the following description taken in conjunction with the accompanying drawings, in which:

FIG. 1 illustrates an example of a floor plan for a merchandising system according to the present invention.

### DETAILED DESCRIPTION OF THE INVENTION

The present invention is directed to a specialized merchandising system for use within a retail establishment to target a particular type of consumer. The specialized merchandising system provides a scheme within the retail establishment offering products and services meeting most, if not all, of the needs of the particular type of consumer and providing a pleasant shopping experience for the customer. The particular type consumer, also referred to as an intended consumer, may be characterized according to age, gender, race, or personal interest such as pets, sports, automotive, gardening and the like. Potential retail establishments harboring such a specialized merchandising system include grocery stores, department stores, supermarkets, superstores, and wholesale clubs.

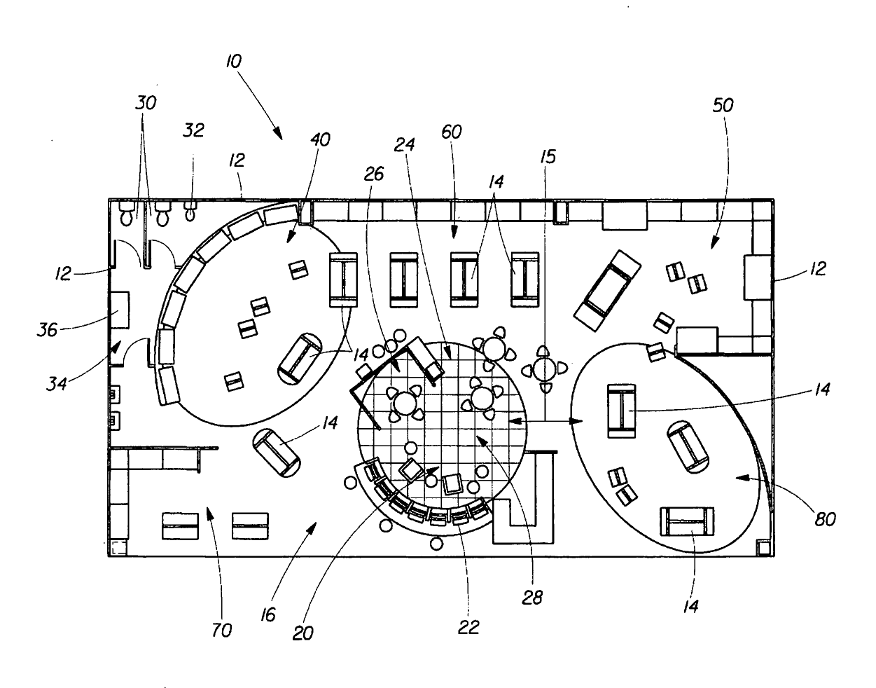

A layout of a specialized merchandising system 10 according to the present invention is illustrated in FIG. 1. The specialized merchandizing system includes a multipurpose customer interaction center 20. The multipurpose customer interaction center 20 is an area within the merchandising system providing access to information and services accommodating the intended consumer. The multipurpose center may include a plurality of computer terminals 22 providing Internet access to online shopping for specialty products and services not sold within the establishment. The computer terminals 22 may also provide the consumer access to educational materials, as well as consumer information pertaining to particular products and services. The computer terminals may also offer scheduling features for setting up trips or planning activities for the particular type of consumer. In addition, the multipurpose center 20 may also include an area where customers can socialize 24 such as a cafe equipped with tables and chairs providing a place for customers to relax and interact with other customers, an activity area for children 26, informative marketing materials, as well as educational materials covering topics of interest to the intended consumer. The multipurpose center 20 may also include public speaking accommodations 28 for guest speakers presenting topics of interest to the intended consumer.

The specialized merchandising system generally comprises a partitioned section within the retail establishment creating a selected area constructed with interior designs and colors that are suitable for the intended consumer. The partitioned section may be separated from other areas of the retail establishments by specific display arrangements, curtains, drapes, dropped ceilings, and/or canopies. Preferably, as shown in FIG. 1, the partitioned section is walled-off on three sides from other areas of the retail establishment by temporary or permanent wall units 12 in order to provide a setting resembling a separate store within the retail establishment.

The partitioned section can be divided into centers offering specific products and services for the intended consumer. For instance, the multipurpose customer interaction center 20, described above, may be located near the middle of the partitioned area surrounded by a nutrition center 40 displaying nutritional food products, an equipment center 50 displaying furnishings, a personal hygiene center 60 displaying personal care products, a clothing center offering the latest fashions, and/or a highlight center 70 displaying seasonal and promotional products.

Merchandising fixtures 14 for displaying products in each of the centers might be built to specifications requiring minimal heights and widths to provide an open look within the partitioned section. The open look provides a wide view that enables customers to keep an eye on their children and to quickly locate the center within the partitioned section supplying a particular product meeting their needs. The merchandising fixtures 14 may also include casters to provide flexibility in organizing displays and also to provide mobility enabling the fixtures to be easily rolled aside in order to enlarge the multipurpose customer interaction center to allow extra room for guest speakers.

Each of the centers may be separated and made accessible by common areas 16 providing pathways therebetween. Different floor patterns may be utilized in order to further distinguish each of the centers. For instance, the flooring throughout the common areas 16 may be the same while the flooring in each of the centers may include separate, distinct floor patterns. For example, hardwood flooring may be used in the common areas 16 and different patterns of tile or linoleum may be used in each of the centers.

In addition to the various centers described above, the specialized merchandising system may include lavatory facilities 30 accommodating adults and children. The lavatory facilities may include separate children toilets 32 and water fountains sized especially for children. The lavatory facilities may also include a changing area 34 equipped with a table 36 for changing diapers.

In one embodiment, the specialized merchandising system may target newborn infants, toddlers, and children under the age of five. For this embodiment, the partitioned section may be constructed with interior designs, colors, and graphics suitable for children. In addition, the centers for this embodiment may be arranged to offer a variety of products and/or services meeting the needs of newborn infants, toddlers, and children under the age of five.

For this embodiment, the multipurpose customer interaction center may include informative marketing materials and/or educational materials pertaining to parenting and child care in general, as well as an activity center providing a place for children to play while their parents shop, relax or interact with other customers in a cafe or other area designed for customers to socialize. A designated area may also be available offering comfortable seating and privacy to mothers breast-feeding their infants. The multipurpose customer interaction center may also include public speaking accommodations for guest speakers presenting topics on parenting and other childcare related matters.

The multipurpose customer interaction center may additionally include computer terminals providing customers Internet access and making available an unlimited variety of products, services, and information. In particular, the computer terminals in the multipurpose customer interaction center may provide customers easy access to websites offering current information pertaining to specific baby care products, baby stages of development, or childcare in general as well as sizing information and appropriate gift ideas relative to age groups. The computer terminals may also provide baby shower registry and planning ideas for celebrations such as birthdays, christenings, etc. The planning ideas may include items such as themes, clowns to hire, and party toy rentals. Further, the computer terminal may also enable customers to organize invitation list and provide a means for actually delivering the invitations to selected invitees via U.S. mail or Email.

Other centers within the specialized merchandising system targeting newborn infants, toddlers, and children under the age of five may include a nutrition center, an equipment center, a hygiene center, a clothing center, and a highlights center. The nutrition center may display everything parents need for dinnertime including food accessories such as bottles, nipples, bottle liners, bibs, sippy cups, and dinnerware and food products ranging from baby food and formula to specialty dinners suitable for toddlers and children under the age of five. The equipment center may provide furnishings such as baby beds, high chairs, strollers, changing tables and the like. The hygiene center may include personal care products such as diapers, wet wipes, baby shampoos, baby washes, baby tubs, tub seats, bath toys, and so on. Further, the clothing center may offer apparel for girls and boys while the highlight center displays promotional items, seasonal products, and/or new products.

In addition to the various centers described above, the specialized merchandising system for newborn infants, toddlers, and children under the age of five may include lavatory facilities incorporating separate toilets and water fountains designed to accommodate children under the age of five. The lavatory facilities may include a changing area equipped with a table for changing diapers and also complementary diapers and wipes supplied by manufactures offering products for sale in the hygiene center.

In another embodiment, the specialized merchandising system may target women. For this embodiment, the partitioned section may be constructed with feminine interior designs and colors and include centers offering a variety of products and/or services that are particularly of interest to women. For instance, a nutrition center may display nutritional and dietary food products marketed mainly for women while an equipment center may display small hair care appliances such as dryers, curling irons, vanity mirrors, etc. In addition, a personal hygiene center for women may display personal care products such as tampons, sanitary napkins, lotions, soaps, shampoos as well as makeup and perfumes.

The specialized merchandising system for women may also include a multi-purpose customer interaction center providing computer terminals, an area where customers can socialize, public speaking accommodations for guest speakers (presenting topics on women's issues), and a library including informative marketing materials for products and educational materials pertaining to women's issues, and an activity area for children accommodating women shopping with children. The computer terminals may provide Internet access for online shopping, making available an unlimited number of products and services manufactured and offered specifically for women. The computer terminals may also provide access to educational materials and scheduling features for planning activities and celebrations such as birthdays, weddings, wedding showers, etc.

In another embodiment, the specialized merchandising system may target exercise enthusiasts. For this embodiment, the partitioned section may be constructed with interior designs and colors representative of various sports themes and include centers offering a variety of products and/or services that are particularly of interest to exercise enthusiasts. For instance, a nutrition center may display nutritional products, energy products, and vitamins marketed for individuals participating in exercise such as weight training, running, swimming etc., while an equipment center may display exercise equipment such as treadmills, stationary bikes, weights etc. A clothing center may provide workout apparel and a personal hygiene center may display ointments for treating muscle pain, cold packs for treating injuries, athlete's foot medication, etc.

The specialized merchandising system for exercise enthusiast may also include a multi-purpose customer interaction center providing computer terminals, an area where customers can socialize such as a juice bar specializing in healthy beverages and food products, public speaking accommodations for guest speakers (presenting topics on various forms of exercise training, health etc.), and a library including informative marketing materials for products and educational materials pertaining to exercise. The computer terminals may provide Internet access for online shopping and make available an unlimited number of products and services manufactured and provided specifically for exercise enthusiast. The computer terminals may also provide access to educational materials and scheduling features for planning activities and registering for various events such as long distance runs, aerobics classes, sporting events, etc.

It should be understood that while particular embodiments and/or features of the invention have been described, it would be apparent to those skilled in the art (given the present description) that various other changes and modifications can be made without departing from the spirit and scope of the invention. Further, it should be apparent that all combinations of such embodiments and/or features are possible and can result in preferred executions of the invention. It is therefore intended to cover in the appended claims all such changes and modifications that are within the spirit and scope of the invention.

What is claimed is:

1. A specialized merchandizing system for a retail establishment targeting toddlers comprising: a partitioned section with a retail store establishment,
wherein the partitioned section comprises at least two divided centers,
wherein the centers are chosen from:
(a) a nutrition center, where in the nutrition center displays food products suitable for toddlers;
(b) an equipment center, wherein the equipment center displays furnishings designed for toddlers;
(c) a hygiene center, wherein the hygiene center displays personal care products manufactured for toddlers;
(d) a clothing center, wherein the clothing center display fashions designed for toddlers.

2. The system of claim 1, further comprising a highlight center, wherein the highlight center displays seasonal products designed for toddlers.

3. The system of claim 1, wherein the partitioned section is chosen from wall units, flooring distinct from the rest of the flooring of the retail store, curtain, drape, dropped ceiling, canopy, or combinations thereof.

4. The system of claim 3, wherein the partitioned section comprises wall units.

5. The system of claim 4, wherein the partitioned section comprises three wall units.

6. The system of claim 5, wherein the system further comprises education materials pertaining to parenting toddlers or toddler care in general.

7. The system according to claim 5, further comprising a computer terminal wherein the terminal is capable of providing a customer Internet access.

8. The system according to claim 6, wherein the system further comprises designs, colors, graphics, or combination thereof suitable for children.

9. The system according to claim 1, wherein the system comprises at least three centers.

10. The system according to claim 9, further comprising a highlight center, wherein the highlight center displays seasonal products designed for toddlers.

11. The system of claim 9, wherein the partitioned section is chosen from wall units, flooring distinct from the rest of the flooring of the retail store, curtain, drape, dropped ceiling, canopy, or combinations thereof.

12. The system of claim 11, wherein the partitioned section comprises three wall units.

13. The system of claim 12, wherein the system further comprises education materials pertaining to parenting toddlers or toddler care in general.

14. The system of claim 12, wherein the system further comprises designs, colors, graphics, or combination thereof suitable for children.

15. The system of claim 1, wherein the system comprises at least four centers.

16. The system of claim 15, further comprising a highlight center, wherein the highlight center displays seasonal products designed for toddlers.

17. The system of claim 15, wherein the partitioned section is chosen from wall units, flooring distinct from the rest of the flooring of the retail store, curtain, drape, dropped ceiling, canopy, or combinations thereof.

18. The system of claim 17, wherein the partitioned section comprises three wall units.

19. The system of claim 18, wherein the system further comprises education materials pertaining to parenting toddlers or toddler care in general.

20. The system of claim 15, further comprising a highlight center, wherein the highlight center displays seasonal products designed for toddlers; and wherein the partitioned section comprises three wall units.
